(19) United States
(12) Patent Application Publication
(10) Pub. No.: US 2015/0003621 A1
(43) Pub. Date: Jan. 1, 2015

(54) PERSONAL NOISE REDUCTION METHOD FOR ENCLOSED CABINS

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/182,198

(22) Filed: Feb. 17, 2014

Related U.S. Application Data
(60) Provisional application No. 61/765,631, filed on Feb. 15, 2013.

(51) Int. Cl. H04R 3/00

(52) U.S. Cl. CPC H04R 3/002; H04R 2410/05
USPC 381/71.1

(57) ABSTRACT

A Personal Noise Reduction for enclosed cabins is disclosed. According to one embodiment, an input audio source corresponding to sound received from multiple microphones situated equidistantly in both directions in a two dimensional plane, is converted to a digital signal via an analog to digital (A/D) convertor. The AID converted audio is analyzed for content to identify ambient noise. The frequency, amplitude and phase of the identified ambient noise is subsequently determined. A Noise correction sound wave is generated with negative phase of that corresponding to the identified ambient noise. The noise correction sound wave is added to the identified noise to create a noise corrected sound.

### CROSS-REFERENCE TO RELATED PATENT APPLICATIONS

Embodiments of the present invention relate to U.S. Provisional Application Ser. No. 61/765,631, filed Feb. 15, 2013, entitled “PERSONAL ACTIVE NOISE CANCELLATION”, the contents of which are incorporated by reference herein and which is a basis for a claim of priority.

### BACKGROUND OF THE INVENTION

The present invention relates to a personal, portable, sound control system which reduces background noise levels and provides a quieter sound environment for the user for work or relaxation. The inventive system and method is suitable for use at any location where user utilizes for work or relaxation, such as office cubicles, hotel rooms, office space at home, and the like.

Personal environments typically utilized for work or relaxation often include interference from surrounding audio sources such as people, devices, motions, etc., which interfere with the person's work or relaxation. For example, hotel guests occupying rooms adjacent to roads are often prevented from getting a restful night by or distracted from work or relaxation during the day by the sounds of moving vehicles using the road. Likewise, workers using cubicles in office environments are often distracted by noise from nearby offices and cubicles.

Conventional approaches for dealing with this problem include “sound masking” which introduces a certain natural or artificial sound (such as white noise or pink noise) into an environment to cover up unwanted sound by using auditory masking. Sound masking reduces or eliminates awareness of pre-existing sounds in a given area and can make a work environment more comfortable.

Conventionally, the term noise cancellation or noise control is used to describe the process of minimizing or eliminating sound emissions from sources that interfere with the listeners' quiet or intended audio source, often for personal comfort, environmental considerations or legal compliance.

Conventional attempts at noise control and cancellation are performed via active or passive means. Active noise control is sound reduction using a power source. Passive noise control refers to sound control by noise-reduction materials, such as insulations and sound-absorbing tiles typically used in homes and offices or moving vehicles, mufflers used in automobiles and the like, rather than a power source.

Active noise canceling is best suited for low frequencies. However, as the target frequencies intended to be reduced become higher, the spacing requirements for free space and zone of silence techniques become prohibitive. This is mostly because the number of modes grows rapidly with increasing frequency, which quickly makes active noise control techniques unmanageable. Therefore, at such higher frequencies, passive treatments become more effective and often provide an adequate solution without the need for active control.

Current active noise reduction techniques involve recognizing the noise in the transmitted or received signal¹. According to the conventional method, once the noise signal is recognized, it is reduced and removed by subtracting it from the transmitted or received signal. This technique is implemented using a digital signal processor (DSP) or software. Adaptive algorithms are designed to analyze the waveform of the background aural or non-aural noise, then based on the specific algorithm generate a signal that will either phase shift or invert the polarity of the original signal. This inverted signal (in anti-phase) is then amplified and a transducer creates a sound wave directly proportional to the amplitude of the original waveform, creating destructive interference. This effectively reduces the volume of the perceivable noise.² ¹http://en.wikipedia.org/wiki/Active_noise_control (internal citations and quotation marks omitted)²See, n.1, above.

Sound is a pressure wave, which consists of a compression phase and a rarefaction phase. A noise-cancellation speaker emits a sound wave with the same amplitude but with inverted phase (also known as antiphase) to the original sound. The waves combine to form a new wave, in a process called interference, and effectively cancel each other out—an effect which is called phase cancellation.³ ³See, n.1, above.

A noise-cancellation speaker may be co-located with the sound source to be attenuated. In this case it must have the same audio power level as the source of the unwanted sound. Alternatively, the transducer emitting the cancellation signal may be located at the location where sound attenuation is wanted (e.g. the user's ear). This requires a much lower power level for cancellation but is effective only for a single user.⁴ ⁴See, n.1, above.

Noise cancellation at other locations is more difficult as the three dimensional wavefronts of the unwanted sound and the cancellation signal could match and create alternating zones of constructive and destructive interference, reducing noise in some spots while doubling noise in others. In small enclosed spaces (e.g. the passenger compartment of a car) global noise reduction can be achieved via multiple speakers and feedback microphones, and measurement of the modal responses of the enclosure.⁵ ⁵See, n.1. above.

Applications can be “1-dimensional” or 3-dimensional, depending on the type of zone to protect. Periodic sounds, even complex ones, are easier to cancel than random sounds due to the repetition in the wave form.⁶ ⁶See, n.1. above.

Protection of a “1-dimension zone” is easier and requires only one or two microphones and speakers to be effective. Several commercial applications have been successful: noise-cancelling headphones, active mufflers, and the control of noise in air conditioning ducts. The term “1-dimension” refers to a simple pistonic relationship between the noise and the active speaker (mechanical noise reduction) or between the active speaker and the listener (headphones).⁷ ⁷See, n.1. above.

Protection of a 3-dimension zone requires many microphones and speakers, making it more expensive. Each of the speakers tends to interfere with nearby speakers, reducing the system's overall performance. Noise reduction is more easily achieved with a single listener remaining stationary but if there are multiple listeners or if the single listener turns his head or moves throughout the space then the noise reduction challenge is made much more difficult. High frequency waves are difficult to reduce in three dimensions due to their relatively short audio wavelength in air. The wavelength in air of sinusoidal noise at approximately 800 Hz is double the distance of the average person's left ear to the right ear; such a noise coming directly from the front will be easily reduced by an active system but coming from the side will tend to cancel at one ear while being reinforced at the other, making the noise louder, not softer.⁸ ⁸See, n.1. above.

High frequency sounds above 1000 Hz tend to cancel and reinforce unpredictably from many directions. In sum, the most effective noise reduction in three dimensional space involves low frequency sounds. Commercial applications of 3-D noise reduction include the protection of aircraft cabins and car interiors, but in these situations, protection is mainly limited to the cancellation of repetitive (or periodic) noise such as engine-, propeller- or rotor-induced noise. This is because an engine's cyclic nature makes fast Fourier transform analysis and the noise cancellation easier to apply.⁹ ⁹See, n.1. above

A new personal noise cancelation method and process is required that addresses the above noted deficiencies of the conventional noise reduction methods.

### SUMMARY OF THE INVENTION

The inventive Personal Noise Reduction (PNR) method and system of the present application is specifically designed for reducing and eliminating ambient noise in a small personal environment such as an office cubicle, a room in a home, a hotel room and the like.

The inventive PNR system includes two or more microphones that are placed in the target cabin in which noise reduction is sought, preferably the microphones are situated in equal distances as needed in a one dimensional arrangement or, in the horizontal and perpendicular directions corresponding to a two-dimensional plane. The number of microphones is determined by the size of the space the system is used in. Preferably, the microphones are of the Cardioids type.

Signals from the microphones are fed to an analog to digital converter, which converts the analog signals received from the microphones to digital signals. The converted digital audio is analyzed for content and ambient noise is identified for further processing. Signals from the microphones are also monitored for changes to the ambient noise. There could be a single or multiple noise frequencies that are identified and subsequently monitored.

Changes to the amplitude, frequency and phase of the ambient noise are subsequently performed as necessary. As such, the system is dynamic as it adapts itself to the new environment, which is continuously monitored for changes.

DSP dynamically changes the phase of the ambient noise, always in a negative amount, of the digital audio received. The negative phase sound is added back to the original noise which results in a reduction or cancellation of the sound wave corresponding to the noise. These changes are dynamic and self adjusting in nature. The modified, noise corrected digital sound output is changed back to an analog signal and fed into the audio playback system for noise reduction.

### BRIEF DESCRIPTION OF THE DRAWINGS

FIG. 1 is a schematic diagram of an exemplary embodiment of the arrangement of speakers and microphones in the Personal Noise Reduction system of the present invention.

FIG. 2 is a block diagram of an exemplary embodiment showing a system incorporating Personal Noise Reduction Module according to the present invention.

### DETAILED DESCRIPTION OF THE PREFERRED EMBODIMENT(S)

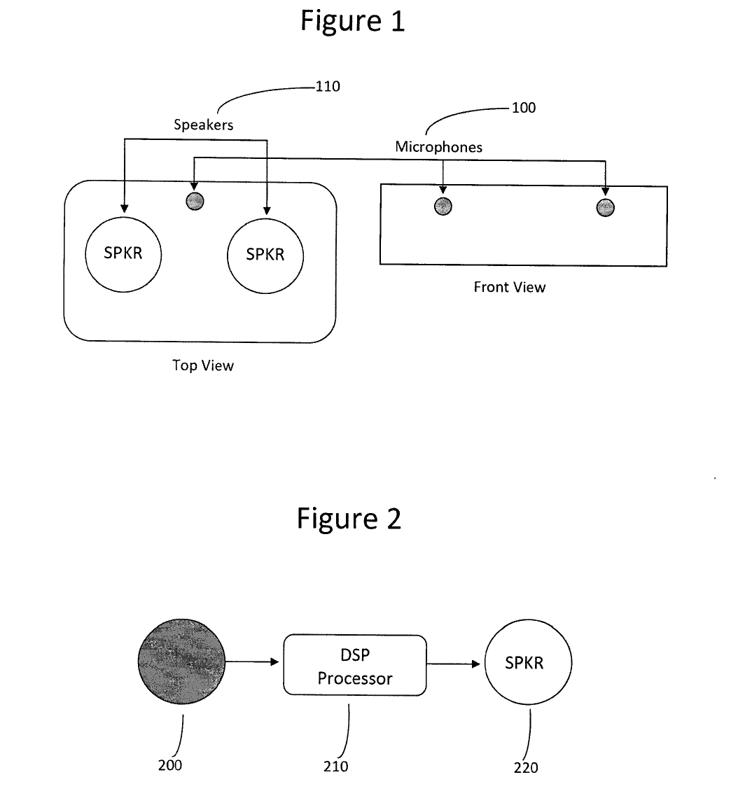

An embodiment of the operation of the Personal Noise Reduction method of the present invention is depicted in the block diagram of FIG. 1. Preferably, the inventive PNR process is performed by a single DSP processor module identified by reference numeral 210 in the system shown in the block diagram of FIG. 2.

As shown in FIG. 1, multiple microphones 100 receive sound from the environment and provide the input audio source for further analysis and processing. Preferably, the microphones are of the Cardioid type. The microphones are two or more in number and are spaced in the personal space targeted for noise reduction in equal distances from each other in a one or two dimensional arrangement as needed.

The input audio from these multiple microphones 100 is fed to an analog-to-digital (A/D) convertor (not shown), where the input audio analog signal is converted to a digital format.

The converted digital audio from the A/D convertor is fed to a digital sound processing module (referenced as DSP in FIG. 2) 210 for processing. The Personal Noise Reduction Module processes the received sound wave.

This process will “listen” to the audio in an environment within a limited range (band pass). Any content in this area will be measured, or sampled, for amplitude. Preferably, the sound measurements will be made at about every 60 seconds.

After the noise has been detected and identified for frequency, a similar, but reverse phase signal will be generated and fed on to the amplifier and speakers. Preferably, the range of the bandpass will be and eight order 200 to 800 Hz FIR digital filter. Preferably, the sample rate shall be 8000 Hz in 15 second bursts. The output audio is phase reversed only. No original sound is output by the system. The phase inversion will be fixed to a constant 180 degrees.

The inventive Personal Noise Reduction method has many applications. For example, When a guest is staying the night at a hotel close to an airport. By using this system user could remove a substantial amount of the exterior noise that enters his/her room, thus having a quieter room in the area where this device is used. It is intended for single room spaces only. Likewise, if a user is in an office cubicle with noisy surrounding, the inventive PNR system will reduce surrounding noise and provide a much more quiet environment for work.

What is claimed is:

1. A Personal Noise Reduction method comprising:
Providing an input audio source;
Converting the input audio source to a digital signal via an analog to digital (A/D) convertor;
Analyzing the A/D converted audio for content and identifying ambient noise;
Determining frequency, amplitude and phase of the identified ambient noise;
Generating a noise correction sound wave with the same frequency and amplitude but negative phase of that corresponding to the identified ambient noise;
Outputting the noise correction sound wave.

2. The Personal Noise Reduction of claim 1 wherein the negative phase is a phase shifted wave with a shift of 180 degrees from the phase of the identified ambient noise.

3. The Personal Noise Reduction of claim 1 further comprising monitoring the A/D converted audio for changes in the identified ambient noise and identifying any additions or changes to the identified ambient noise.

4. The Personal Noise Reduction of claim 1, wherein the input audio source is received from multiple microphones situated in the enclosed cabin.

5. The Personal Noise Reduction of claim 4, wherein the microphones are of Cardiod type.

6. The Personal Noise Reduction of claim 4, wherein the enclosed cabin is a hotel room.
